(19) United States
(12) Patent Application Publication
(10) Pub. No.: US 2026/0287939 A1
(43) Pub. Date: Sep. 24, 2026

(54) HYBRID ELECTRO-OPTIC PHASE SHIFTERS

(71) Applicant: GlobalFoundries U.S. Inc., Malta, NY (US)

(72) Inventors: Stefan Dünkel, Dresden (DE); Halid Mulaosmanovic, Dresden (DE); Judson R. Holt, Ballston Lake, NY (US); Yusheng Bian, Ballston Lake, NY (US)

(21) Appl. No.: 19/083,628

(22) Filed: Mar. 19, 2025

(51) Int. Cl. G02F 1/015; G02F 1/00; G02F 1/025

(52) U.S. Cl. CPC G02F 1/0154; G02F 1/0027; G02F 1/025; G02F 2201/063; G02F 2201/42

(57) ABSTRACT

Structures for an electro-optic phase shifter and methods of forming a structure for an electro-optic phase shifter. The structure comprises a waveguide core, a ferroelectric layer that overlaps with a section of the waveguide core, and an interconnect coupled to the ferroelectric layer. The ferroelectric layer comprises a ferroelectric material, and the interconnect is configured to be coupled to a power supply.

### BACKGROUND

The disclosure relates to photonic chips and, more specifically, to structures for an electro-optic phase shifter and methods of forming a structure for an electro-optic phase shifter.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

A phase shifter is a photonic component that can be used on a photonic chip to modulate the phase of light propagating in a waveguide core. One type of phase shifter may operate by a thermo-optic mechanism in which heat is transferred to the waveguide core, which is comprised of a material having a refractive index that varies with temperature. Another type of phase shifter may operate by an electro-optic mechanism by biasing a p-n junction inside the waveguide core. Conventional electro-optic phase-shifters are limited by an inability to achieve non-volatility and by a fundamental tradeoff between speed and other figures of merit, such as bandwidth.

Improved structures for an electro-optic phase shifter and methods of forming a structure for an electro-optic phase shifter are needed.

### SUMMARY

In an embodiment of the invention, a structure for an electro-optic phase shifter is provided. The structure comprises a waveguide core, a ferroelectric layer that overlaps with a section of the waveguide core, and an interconnect coupled to the ferroelectric layer. The ferroelectric layer comprises a ferroelectric material, and the interconnect is configured to be coupled to a power supply.

In an embodiment of the invention, a method of forming a structure for an electro-optic phase shifter is provided. The method comprises forming a waveguide core, and forming a ferroelectric layer that overlaps with a section of the waveguide core, and forming an interconnect that is coupled to the ferroelectric layer. The ferroelectric layer comprises a ferroelectric material, and the interconnect is configured to be coupled to a power supply.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 1A is a cross-sectional view taken generally along line 1A-1A in FIG. 1.

FIG. 2 is a top view of the structure at a fabrication stage of the processing method subsequent to FIGS. 1, 1A.

FIG. 2A is a cross-sectional view taken generally along line 2A-2A in FIG. 2.

FIG. 3 is a cross-sectional view of the structure at a fabrication stage of the processing method subsequent to FIGS. 2, 2A.

FIG. 4 is a cross-sectional view of a structure in accordance with alternative embodiments of the invention.

FIG. 5 is a cross-sectional view of a structure in accordance with alternative embodiments of the invention.

FIG. 6 is a cross-sectional view of a structure in accordance with alternative embodiments of the invention.

FIG. 7 is a cross-sectional view of a structure in accordance with alternative embodiments of the invention.

FIG. 8 is a top view of a structure at an initial fabrication stage of a processing method in accordance with alternative embodiments of the invention.

FIG. 8A is a cross-sectional view taken generally along line 8A-8A in FIG. 8.

FIG. 9 is a cross-sectional view of a structure in accordance with alternative embodiments of the invention.

FIG. 10 is a cross-sectional view of a structure in accordance with alternative embodiments of the invention.

FIG. 11 is a cross-sectional view of a structure in accordance with alternative embodiments of the invention.

FIG. 12 is a top view of a structure in accordance with alternative embodiments of the invention.

### DETAILED DESCRIPTION

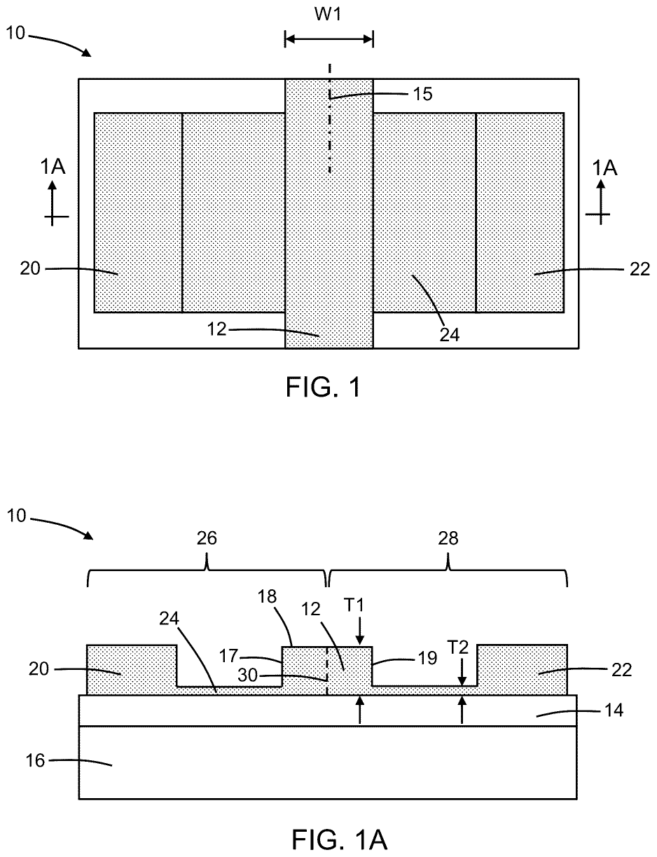

With reference to FIGS. 1, 1A and in accordance with embodiments of the invention, a structure 10 for an electro-optic phase shifter includes a waveguide core 12 that is disposed on, and overlies, a dielectric layer 14 and a semiconductor substrate 16 of a photonics chip. In an embodiment, the dielectric layer 14 may be comprised of a dielectric material, such as an oxide like silicon dioxide, and the semiconductor substrate 16 may be comprised of a semiconductor material, such as single-crystal silicon. In an embodiment, the dielectric layer 14 may be a buried oxide layer of a silicon-on-insulator substrate.

In an embodiment, the waveguide core 12 may be comprised of a material having a refractive index that is greater than the refractive index of silicon dioxide. In an embodiment, the waveguide core 12 may be comprised of a semiconductor material, such as silicon. In an embodiment, the waveguide core 12 may be formed by depositing a layer comprised of its constituent material and patterning the deposited layer with lithography and etching processes. The waveguide core 12 may have a width dimension W1 and may extend along a longitudinal axis 15.

The waveguide core 12 has a sidewall 17, a top surface 18, a sidewall 19 opposite from the sidewall 17, and a bottom surface that is opposite from the top surface 18 and that adjoins the dielectric layer 14. The electro-optic phase shifter includes a ridge 20, a ridge 22, and a slab layer 24 that couples a section of the waveguide core 12 to the ridges 20, 22. The section of the waveguide core 12 is positioned in a lateral direction between the ridge 20 and the ridge 22, the slab layer 24 connects the ridge 20 to the sidewall 17 of the waveguide core 12, and the slab layer 24 connects the ridge 22 to the sidewall 19 of the waveguide core 12. The waveguide core 12 has a thickness T1, relative to the plane of the dielectric layer 14, and the slab layer 24 has a thickness T2, also relative to the plane of the dielectric layer 14, that is less than the thickness T1. The slab layer 24 is formed by partially etching through the layer of material that is patterned to form the waveguide core 12 and the ridges 20, 22.

A doped region 26 may be formed in the ridge 20, the section of the waveguide core 12, and the portion of the slab layer 24 between the ridge 20 and the section of the waveguide core 12. In an embodiment, the doped region 26 may contain a concentration of an n-type dopant, such as phosphorus, to provide n-type conductivity. The doped region 26 may be formed by implanting ions, such as ions including the n-type dopant, with an implantation mask having an opening defining the intended location for the doped region 26. The implantation conditions, such as ion species, dose, and kinetic energy, may be selected to tune the electrical and physical characteristics of the doped region 26.

A doped region 28 may be formed in may be formed in the ridge 22, the section of the waveguide core 12, and the portion of the slab layer 24 between the ridge 22 and the section of the waveguide core 12. In an embodiment, the doped region 28 may contain a concentration of a p-type dopant, such as boron, to provide p-type conductivity. The doped region 28 may be formed by implanting ions, such as ions including the p-type dopant, with an implantation mask having an opening defining the intended location for the doped region 28. The implantation conditions, such as ion species, dose, and kinetic energy, may be selected to tune the electrical and physical characteristics of the doped region 28.

The doped region 26 has an opposite conductivity type from the doped region 28. The doped region 26 may adjoin the doped region 28 to form a p-n junction 30 inside the section of the waveguide core 12 that is connected to the ridges 20, 22 by the slab layer 24. The p-n junction 30 may extend parallel to the sidewalls 17, 19 of the waveguide core 12. Light propagates along the length the waveguide core 12 in a direction parallel to the p-n junction 30.

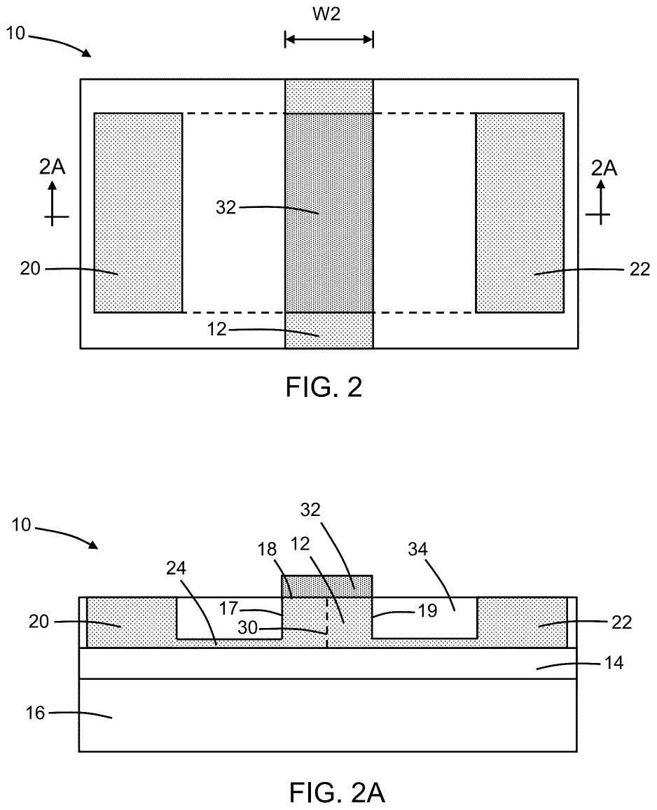

With reference to FIGS. 2, 2A in which like reference numerals refer to like features in FIGS. 1, 1A and at a subsequent fabrication stage, a dielectric layer 34 may be formed that surrounds the waveguide core 12 and fills the recesses above the slab layer 24. The dielectric layer 34 may be comprised of a dielectric material, such as silicon dioxide, having a refractive index that is less than the refractive index of the material constituting the waveguide core 12. The dielectric layer 34 may be deposited and planarized.

A ferroelectric layer 32 may be formed that overlies the top surface 18 of a section of the waveguide core 12. In an embodiment, the ferroelectric layer 32 may fully overlap with the top surface 18 of the section of the waveguide core 12. In an embodiment, the ferroelectric layer 32 may adjoin and directly contact the top surface 18 of the section of the waveguide core 12. In an embodiment, the ferroelectric layer 32 may adjoin and directly contact only the top surface 18, and not the sidewalls 17, 19, of the section of the waveguide core 12 because of the dielectric layer 34 occupying the spaces between the waveguide core 12 and the ridges 20, 22 before forming the ferroelectric layer 32. In an embodiment, the ferroelectric layer 32 may have a width dimension W2 that is equal to the width dimension W1 of the waveguide core 12.

The ferroelectric layer 32 may be comprised of a ferroelectric material. In an embodiment, the ferroelectric material of the ferroelectric layer 32, which is an electrical insulator, may have a permittivity that is greater than the permittivity of the dielectric material of the waveguide core 12. The ferroelectric material constituting the ferroelectric layer 32 may be deposited by, for example, by atomic layer deposition and crystallized by an anneal following deposition. In an embodiment, the ferroelectric layer 32 may include crystalline grains characterized by an orthorhombic phase that is ferroelectric. In an embodiment, the ferroelectric material may be comprised of a hafnium-based material. In an embodiment, the ferroelectric material may be comprised of hafnium oxide. In an embodiment, the ferroelectric material may be comprised of an oxide that contains hafnium and zirconium. In an embodiment, the ferroelectric material may be comprised of hafnium zirconium oxide. In an embodiment, a thin interfacial layer comprised of silicon oxide (e.g., silicon dioxide) may be positioned between the ferroelectric layer 32 and the top surface 18 of the section of the waveguide core 12.

The grains of ferroelectric material constituting the ferroelectric layer 32 are characterized by a pair of remanent polarization states that can be reversibly varied in response to an applied voltage and that are persistent and non-volatile after the electric field associated with the applied voltage is removed. In one remnant polarization state, the polarization of the ferroelectric material in an arbitrary grain may be oriented parallel to the normal to the top surface 18 of the waveguide core 12. In the other remnant polarization state, the polarization of the ferroelectric material in an arbitrary grain may be oriented anti-parallel to the normal to the top surface 18 of the waveguide core 12. The net remnant polarization of the ferroelectric layer 32 is given by a sum of the individual remanent polarization states of the grains. The ferroelectric layer 32 may have a net remnant polarization for a given applied voltage in which the ferroelectric material of all, or substantially all, of the grains have individual polarizations that are oriented parallel to the normal to the top surface 18 of the waveguide core 12. The ferroelectric layer 32 may have a net remnant polarization for a given applied voltage in which the ferroelectric material of all, or substantially all, of the grains have individual polarizations that are oriented anti-parallel to the normal to the top surface 18 of the waveguide core 12. The ferroelectric layer 32 may be tunable between the net remnant polarization in which the ferroelectric material of all, or substantially all, of the grains have individual polarizations that are oriented parallel to the normal to the top surface 18 and the net remnant polarization for a given applied voltage in which the ferroelectric material of all, or substantially all, of the grains have individual polarizations that are oriented anti-parallel to the normal to the top surface 18. The ferroelectric layer 32 may also be tunable to a partial or intermediate net remnant polarization in which the grains of the ferroelectric material have a mixture of parallel polarizations and anti-parallel polarizations relative to the normal to the top surface 18 of the waveguide core 12.

In an alternative embodiment, the doped region 26 and the doped region 28 may be omitted such that the waveguide core 12 lacks the p-n junction 30.

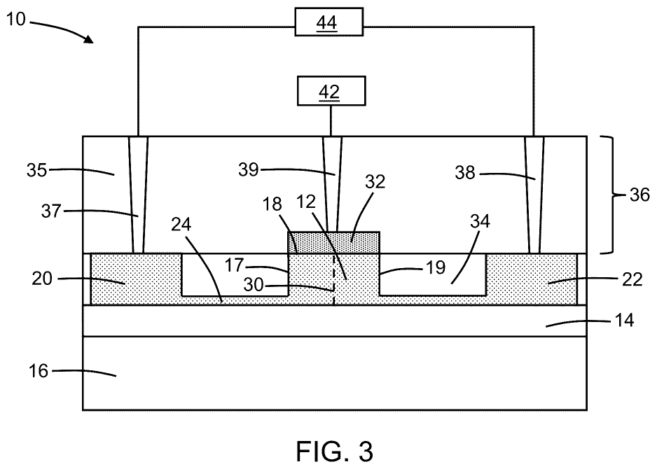

With reference to FIG. 3 in which like reference numerals refer to like features in FIGS. 2, 2A and at a subsequent fabrication stage, a back-end-of-line stack 36 may be formed that overlies the dielectric layer 34. The back-end-of-line stack 36 may include dielectric layers 35, interconnects 37, 38 in the dielectric layers 35 that are coupled to the ridges 20, 22, and an interconnect 39 in the dielectric layers 35 that is coupled to the ferroelectric layer 32. The dielectric layers 35 of the back-end-of-line stack 36 may each be comprised of a dielectric material, such as silicon dioxide, silicon nitride, tetraethylorthosilicate silicon dioxide, or fluorinated-tetraethylorthosilicate silicon dioxide. The interconnects 37, 38, 39 may be comprised of a metal, such as copper or aluminum, and may include a stack of connected vias and wires arranged in multiple metallization levels of the back-end-of-line stack 36. The interconnects 37, 38 may couple the ridges 20, 22 to a power supply 40 such that the p-n junction 30 can be biased by, for example, a modulated electrical signal. The interconnect 39 may couple the ferroelectric layer 32 to a power supply 42 such that the net remnant polarization of the ferroelectric layer 32 can be established by, for example, the application of a pulse of control voltage before operation and/or during operation of the electro-optic phase shifter. In an embodiment, the ferroelectric layer 32 may be arranged between the interconnect 39 and the top surface 18 of the waveguide core 12.

In use, the waveguide core 12 may guide propagating light along a light path parallel to the longitudinal axis 15 such that the highest optical intensity region of the optical mode is disposed within the waveguide core 12 and immediately adjacent to the sidewalls 17, 19 and top surface 18 of the waveguide core 12. The p-n junction 30 of the electro-optic phase shifter is biased using the power supply 40 to change the effective refractive index of the associated section of the waveguide core 12 and thereby change the phase of the propagating light. The biasing of the p-n junction 30 may be modulated to modulate the phase of the propagating light. The ferroelectric layer 32 of the electro-optic phase shifter is biased with a control voltage using the power supply 42 to generate an electric field oriented in a vertical direction. The net remnant polarization of the ferroelectric layer 32 may be effective to change light confinement in the section of the waveguide core 12 that includes the p-n junction 30. The net remnant polarization of the ferroelectric layer 32, which may be perpendicular to the light path in the waveguide core 12, may also be effective to change the effective refractive index of the section of the waveguide core 12 that includes the p-n junction 30.

The electro-optic phase shifter embodied in the structure 10 has a hybrid construction due to the integration of the ferroelectric layer 32. The hybrid electro-optic phase shifter embodied in the structure 10 may have a higher efficiency than conventional electro-optic phase shifters because of, among other factors, a higher mode confinement enabled by the ferroelectric layer 32. The electro-optic phase shifter embodied in the structure 10 is characterized by non-volatility and may achieve higher bandwidths than conventional electro-optic phase shifters. The electro-optic phase shifter embodied in the structure 10 may be more compact due to the inclusion of the ferroelectric layer 32 and may be compatible with complementary metal-oxide-semiconductor processes. The electro-optic phase shifter embodied in the structure 10 may be characterized by tunable and reconfigurable wavelength selection through partial net remnant polarization switching, as well as low power operation due to the non-volatility of the ferroelectric layer 32.

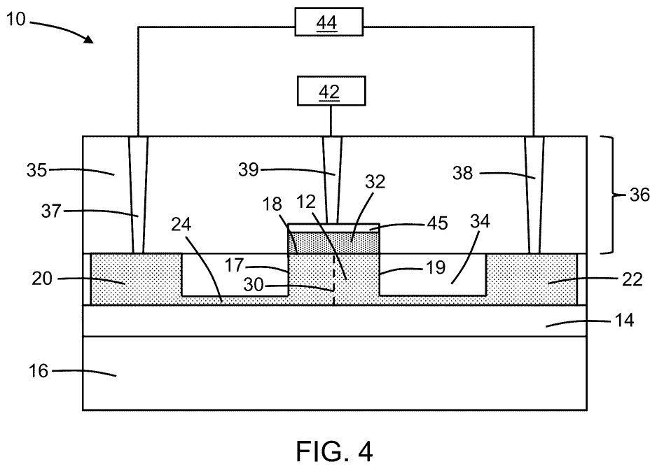

With reference to FIG. 4 and in accordance with alternative embodiments, the structure 10 may include a cap layer 45 that is positioned on the ferroelectric layer 32. In an embodiment, the cap layer 45 may directly contact the ferroelectric layer 32. The cap layer 45 may be comprised of a different material than the ferroelectric layer 32. In an embodiment, the cap layer 45 may be comprised of polycrystalline silicon, amorphous silicon, or crystalline silicon. In an alternative embodiment, the cap layer 45 may be comprised of a dielectric material, such as silicon nitride.

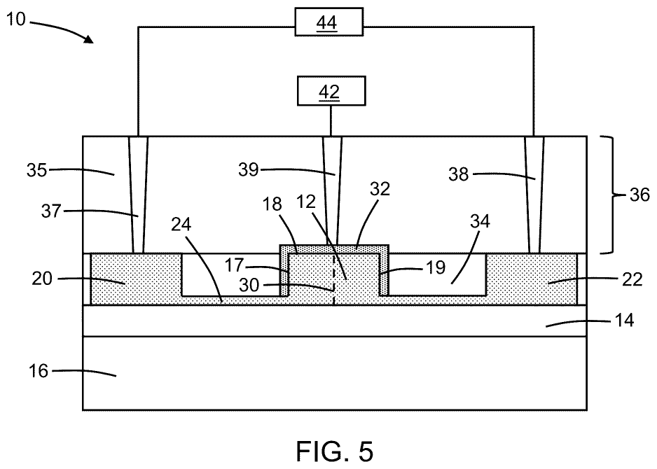

With reference to FIG. 5 and in accordance with alternative embodiments, the ferroelectric layer 32 may wrap around an exterior of the waveguide core 12. In an embodiment, the ferroelectric layer 32 may adjoin the sidewalls 17, 19 and the top surface 18 of the waveguide core 12. To facilitate the wrap-around arrangement, the ferroelectric layer 32 may be formed before the dielectric layer 34 is formed.

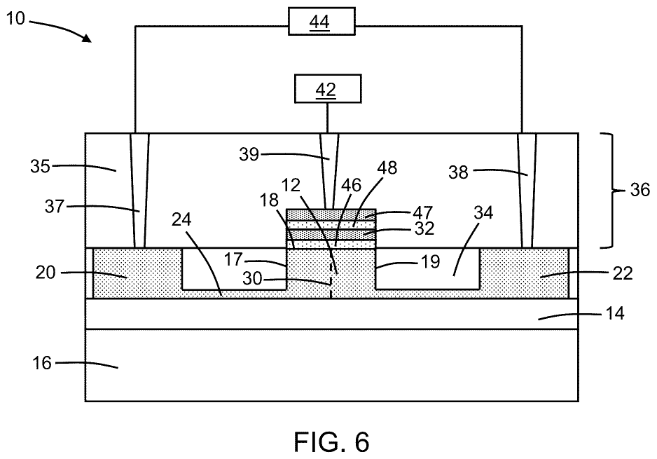

With reference to FIG. 6 and in accordance with alternative embodiments, the structure 10 may include a dielectric layer 46 between the ferroelectric layer 32 and the top surface 18 of the waveguide core 12, a ferroelectric layer 47, and a dielectric layer 48 between the ferroelectric layer 32 and the ferroelectric layer 47. The dielectric layer 46 and the dielectric layer 48 may be comprised of a dielectric material, such as aluminum oxide, that is an electrical insulator. In an alternative embodiment, the cap layer 45 may be positioned on the ferroelectric layer 47. The ferroelectric layer 47 may, in combination with the ferroelectric layer 32, boost the efficiency of the electro-optic phase shifter embodied in the structure 10.

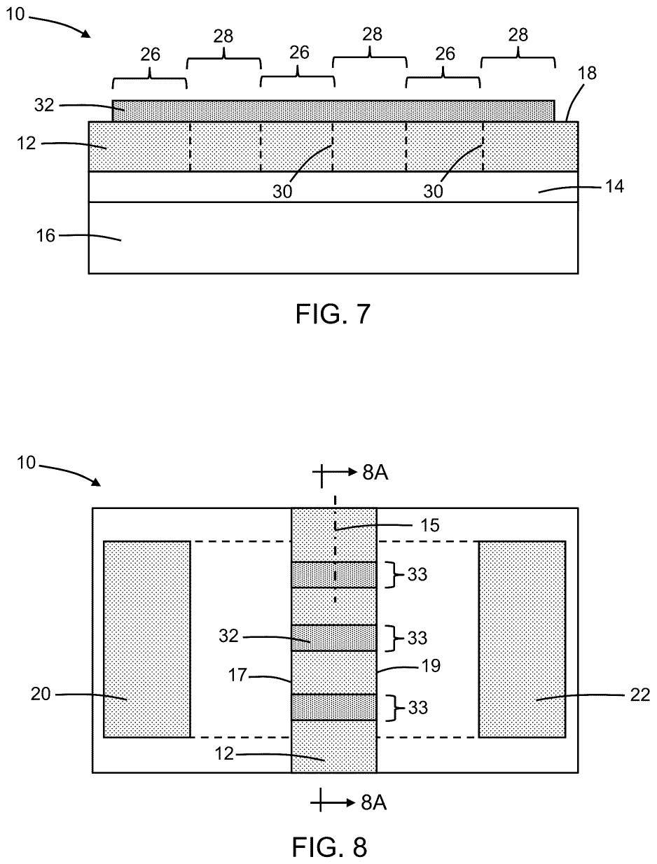

With reference to FIG. 7 and in accordance with alternative embodiments, the structure 10 may include multiple doped regions 26, multiple doped regions 28 interleaved with the doped regions 26, and multiple p-n junctions 30. The doped regions 26 may alternate with the doped regions 28 along the length of the waveguide core 12 such that the p-n junctions 30 are spaced along the longitudinal axis 15 and length of the waveguide core 12. In an embodiment, the ferroelectric layer 32 may overlap with all of the p-n junctions 30 inside the waveguide core 12. The p-n junctions 30 extend from the sidewall 17 to the sidewall 19 instead of along the length of the section of the waveguide core 12 that is overlapped by the ferroelectric layer 32.

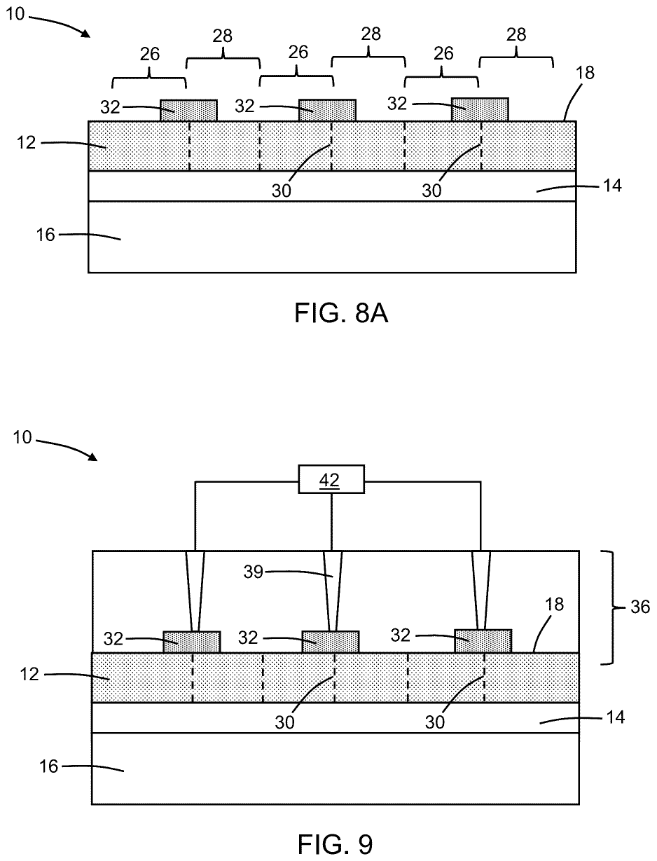

With reference to FIGS. 8, 8A and in accordance with alternative embodiments, the ferroelectric layer 32 may be divided into segments 33 that are distributed with a spaced arrangement along the longitudinal axis 15 of the waveguide core 12. Each of the segments 33 of the ferroelectric layer 32 may overlap with one of the p-n junctions 30, and the segments 33 of the ferroelectric layer 32 may be disconnected from each other.

With reference to FIG. 9 and in accordance with alternative embodiments, the ferroelectric layer 32 may be patterned into the segments 33, and all of the segments 33 of the ferroelectric layer 32 may be jointly coupled by the interconnects 39 to the power supply 42 such that a common control voltage can be applied. The net remnant polarization of the ferroelectric layer 32 can be established by, for example, the application of a pulse of control voltage to the segments 33 of the ferroelectric layer 32 before operation and/or during operation of the electro-optic phase shifter.

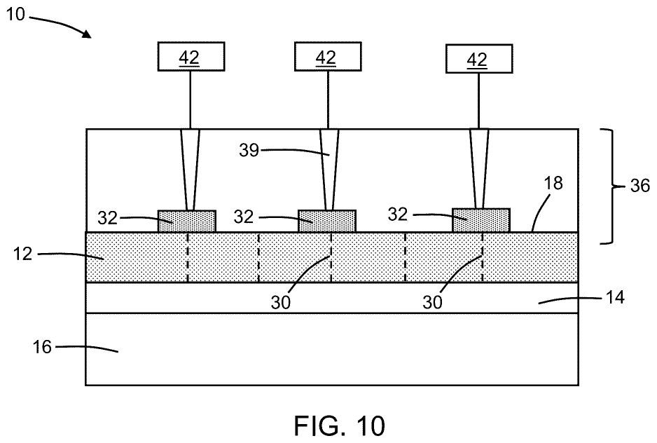

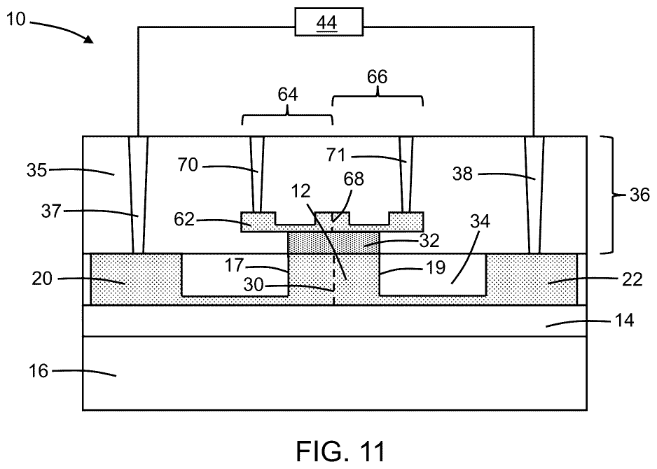

With reference to FIG. 10 and in accordance with alternative embodiments, the ferroelectric layer 32 may be patterned into the segments 33, and the segments 33 of the ferroelectric layer 32 of the electro-optic phase shifter may be individually coupled by the interconnects 39 to different power supplies 42 such that different control voltages can be applied to the segments 33. Each segment of the ferroelectric layer 32 may be independently biased by the different power supplies 42 such that the net remnant polarization of each individual segment 33 of the ferroelectric layer 32 can be independent established by, for example, the application of a pulse of control voltage before operation and/or during operation of the electro-optic phase shifter.

With reference to FIG. 11 and in accordance with alternative embodiments, a layer 62 may be positioned on the ferroelectric layer 32 of the electro-optic phase shifter as a cap layer. In an embodiment, the layer 62 may directly contact the ferroelectric layer 32. The layer 62, which may be comprised of silicon, may include a doped region 64, a doped region 66 having an opposite conductivity type from the doped region 64, and a p-n junction 68 at the interface between the doped region 64 and the doped region 66. Interconnects 70, 71 may be respectively coupled to the doped regions 64, 66 for biasing the p-n junction 68.

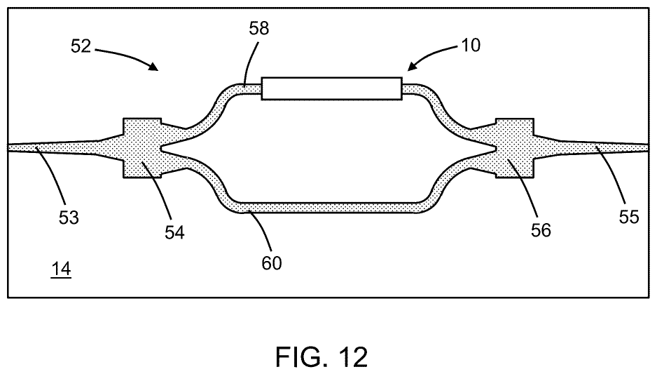

With reference to FIG. 12 and in accordance with alternative embodiments, a Mach-Zehnder interferometer 52 includes an input optical coupler 54, an output optical coupler 56, and waveguide cores 58, 60 defining arms that are separately routed from respective output ports of the input optical coupler 54 to respective input ports of the output optical coupler 56. An input waveguide core 53 is coupled to an input port of the input optical coupler 54, and an output waveguide core 55 coupled to an output port of the output optical coupler 56. One of the arms of the Mach-Zehnder interferometer 52 may integrate a hybrid electro-optic phase shifter embodied in the structure 10. The hybrid electro-optic phase shifter may be used to generate a phase difference between the light propagating in the different waveguide cores 58, 60 of the Mach-Zehnder interferometer 52.

In an alternative embodiment, the hybrid electro-optic phase shifter embodied in the structure 10 may be integrated into a micro-ring resonator. In an alternative embodiment, the hybrid electro-optic phase shifter embodied in the structure 10 may be integrated into a ring-assisted Mach-Zehnder interferometer.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/−10% of the stated value(s) or the stated condition(s).

References herein to terms such as “vertical”, “horizontal”, etc. are made by way of example, and not by way of limitation, to establish a frame of reference. The term “horizontal” as used herein is defined as a plane parallel to a conventional plane of a semiconductor substrate, regardless of its actual three-dimensional spatial orientation. The terms “vertical” and “normal” refer to a direction in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. A feature may “overlie” another feature if the feature is positioned in elevation over another feature. Different features may “overlap” if a feature extends over, and covers all or a part of, another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for an electro-optic phase shifter, the structure comprising:
a waveguide core including a section;
a first ferroelectric layer that overlaps with the section of the waveguide core, the first ferroelectric layer comprising a ferroelectric material; and
a first interconnect coupled to the first ferroelectric layer, the first interconnect configured to be coupled to a first power supply.

2. The structure of claim 1 wherein the section of the waveguide core includes a p-n junction, and the p-n junction is overlapped by the first ferroelectric layer.

3. The structure of claim 1 further comprising:
a second ferroelectric layer that overlaps with the first ferroelectric layer, the second ferroelectric layer comprising the ferroelectric material.

4. The structure of claim 3 further comprising:
a dielectric layer between the first ferroelectric layer and the second ferroelectric layer.

5. The structure of claim 4 wherein the dielectric layer comprises aluminum oxide.

6. The structure of claim 3 wherein the section of the waveguide core includes a p-n junction, and the p-n junction is overlapped by the first ferroelectric layer and the second ferroelectric layer.

7. The structure of claim 1 wherein the waveguide core has a top surface, and the first ferroelectric layer adjoins the top surface of the waveguide core.

8. The structure of claim 1 wherein the ferroelectric material comprises hafnium.

9. The structure of claim 1 wherein the ferroelectric material comprises hafnium and zirconium.

10. The structure of claim 1 wherein the waveguide core has a first side surface, a second side surface, and a top surface, and the first ferroelectric layer adjoins the top surface, the first side surface, and the second side surface of the waveguide core.

11. The structure of claim 1 further comprising:
a cap layer on the first ferroelectric layer, the cap layer comprising a material different from the ferroelectric material.

12. The structure of claim 1 further comprising:
a cap layer on the first ferroelectric layer, the cap layer including a first p-n junction.

13. The structure of claim 12 wherein the section of the waveguide core includes a second p-n junction.

14. The structure of claim 1 wherein the waveguide core has a longitudinal axis, the section of the waveguide core includes a first p-n junction and a second p-n junction spaced from the first p-n junction along the longitudinal axis of the waveguide core.

15. The structure of claim 14 wherein the first p-n junction and the second p-n junction are overlapped by the first ferroelectric layer.

16. The structure of claim 14 wherein the first ferroelectric layer includes a first segment and a second segment disconnected from the first segment, the first segment of the first ferroelectric layer overlaps the first p-n junction, and the second segment of the first ferroelectric layer overlaps the second p-n junction.

17. The structure of claim 1 further comprising:
a semiconductor substrate,
wherein the section of the waveguide core is positioned between the first ferroelectric layer and the semiconductor substrate.

18. The structure of claim 1 wherein the section of the waveguide core includes a p-n junction, a first doped region, and a second doped region that adjoins the first doped region along the p-n junction.

19. The structure of claim 18 further comprising:
a second interconnect coupled to the first doped region; and
a third interconnect coupled to the second doped region,
wherein the second interconnect and the third interconnect are configured to be coupled to a second power supply.

20. A method of forming a structure for an electro-optic phase shifter, the method comprising:
forming a waveguide core;
forming a ferroelectric layer that overlaps with a section of the waveguide core; and
forming an interconnect coupled to the ferroelectric layer,
wherein the ferroelectric layer comprises a ferroelectric material, and the interconnect is configured to be coupled to a power supply.
